(19) United States
(12) Patent Application Publication
(10) Pub. No.: US 2005/0001496 A1
(43) Pub. Date: Jan. 6, 2005

(54) Perpetual motion fan module

(76) Inventor: Rudolph V. Bailey SR., Bear, DE (US)

Correspondence Address: RUDOLPH V. BAILEY SR., 140 ANTLERS LANE, BEAR, DE, 19701, US

(21) Appl. No.: 10/811,382

(22) Filed: Mar. 27, 2004

Related U.S. Application Data
(63) Continuation of application No. 10/075,569, filed on Feb. 13, 2002, now abandoned.
(60) Provisional application No. 60/303,871, filed on Jul. 9, 2001.
(60) Provisional application No. 60/349,731, filed on Jan. 17, 2002.

(51) Int. Cl. H02K 7/10

(52) U.S. Cl. 310/100

(57) ABSTRACT

A means for creating perpetual motion of a battery operated device has been disclosed. A battery operated device such as a large commercial fan can be made to operate continuously eliminating the need for a separate re-charging process for the batteries as long as the fan is kept in operation. This can be accomplished having at least two batteries which are connected in series to give the desired volts, and at least two charging components to charge each battery separately, as the fan is used.

This Application is a continuation of co-pending application Ser. No. 10/075,569 filed on Feb. 13, 2002, which claimed the benefit of prior application Ser. Nos. 60/303,871 filed on Jul. 9, 2001, and 60/349,731 filed on Jan. 17, 2002.

### BACKGROUND OF THE INVENTION

This version of the invention is concerned with the field of battery operated devices, which employs a system of re-charging the batteries while the device is in use, therefore allowing the device to operate continuously.

### PRIOR ART

A variety of battery operated devices are on the market, which uses re-chargeable batteries, but they all possess common limitations, which are as flowing: their duration of operation is limited to the fact that the battery or batteries must be re-charged. This means that the said operation must be stopped for the re-charging or replacement of the said batteries. In addition to that the batteries gets weaker and weaker as they are used, therefore not allowing full efficiency of the devices they are used to operate.

What is needed therefore to overcome these limitations is a way to replenish the batteries while the device is in use, so that no interruption of the operation would be needed for re-charging process.

### DISCUSSION OF THE PRIOR ART

Attempts are continuously being made to fill this need as is exemplified in U.S. Pat. No. 4,648,013, Self-charging Solar Batteries, issued to Raymond F. Curiel on Mar. 3, 1987, U.S. Pat. No. 5,998,965 Direct Plug in Power Tool Using Single Pair Of Contacts For Both AC And DC Currents, issued to Vito J. Carlucci, and Harold R. Taylor on Dec. 7, 1999; U.S. Pat. No. 4,677,362 Apparatus For Storing And Charging A Re-chargeable Electric Tool, issued to Lawrence E. House, II and William H. O'Connor on Jan. 30, 1987.

As illustrated by the background art, efforts are continuously being made in an attempt to develop ways of re-charging battery operated devices as they are being used, however all of these attempts fall short of their intended purpose, as they suffer from other limitations. For example with both the inventions of House and Carlucci, one must have an electrical outlet to perform the re-charging as the device is used. In a situation where no electrical outlet is available their Systems would not work. In addition the users mobility would be limited to the length of the charging cord. In Cruel's invention solar plates are installed in the device in order to use the Sun's rays to accomplish the re-charging of the battery as the device is used, however the Sun does not always shine, so that system cannot be relied on for continuous use. No prior effort provides the benefits attendant with the present invention. As such, it may be appreciated that there is a continuing need for a new and improved system to replenish batteries of a battery operated device as said device is used. In this respect, the present version of the invention substantially departs from the conventional concepts, and designs of the prior art, and in so doing provides a system that substantially fulfills this need. Additionally, the prior patents and commercial techniques do not suggest the present inventive combination of component eliminates arraigned and configured as disclosed herein.

The present invention achieves its intended purposes, objects, and advantages through a new, useful and unobvious combination of methods steps and component elements, with the use of a minimum number of functioning parts, at a reasonable cost to manufacture, and by employing only readily available materials.

### SUMMARY

The present version of the invention, which will be described in greater detail hereinafter, relates to the field of large battery operated devices which uses re-chargeable batteries. More specifically, This version of the invention is concerned with a Battery operated Fan module, which incorporates a system of re-cycling the energy within the device; and using it over and over to replenish the batteries as the Fan is used, in order to produce continual normal operation of the device, for the normal life cycle of the batteries, and the electro/mechanical components. My version of the invention overcomes all of the shortcomings listed previously, in addition to novel aspects that will be described in detail hereinafter.

Described briefly, according to a typical embodiment, the invention presents a Fan Module for the purpose of moving air for the comfort of human kind, or animals, especially in a situation where no other electrical supply is available, or applicable. The device is comprised in general of a base of casement, two 12-volt deep cycle batteries connected in series to give 24-volts, two 24-volt motors wired to operate in a counter clockwise rotation, two chain and sprocket and drive shaft assemblies; and two 12-volt alternators which are used to replenish each battery separately using a double pulley and belt assemble on a common shaft.

The device also includes a fan that is driven by a pulley and belt drive, and meters switches and controls that are mounted on a control panel. As the device is operated the motors transforms the electrical current from the batteries, into turning motion. The said turning motion is transmitted to a drive shaft via the chain and sprocket assemblies. The said turning motion from said shaft operates a fan, and both alternators simultaneously. The fan blades causes the movement of air, while the alternators converts the said turning motion back to electrical energy, which is then used to replenish the batteries. As this process is repeated the device is kept in continuous operation. While some of the energy is lost due to friction, this is offset by the fact that both alternators together can produce more electrical energy than is needed to operate the device, hens the friction can be overcome. While the law of energy conversion states that one can only get as much energy out of a machine as is put into it, this system devises an exception to this rule. This is my explanation; since it takes 24-volts to operate the device, and each 12-volt alternator can produce 14.95-volts, this would mean we are using 24-volts to produce 14.95-volts, this does not violate the law of energy conversion. The fact that we can duplicate this with the same turning motion means we can produce 29.9-volts from 24-volts; therefore we can over come all losses to due to friction and replenish the batteries, if the machine is made as efficiently as possible. There are some ways we can reduce friction, for example if all major parts as possible were to operate in a counter-clockwise rotation instead of clockwise, friction would be reduced, as they would be moving in concert with the earth's rotation. One can notice this principle in action as water drains from your bath tube, it turns on its own in a counter-clockwise rotation, in concert with the Earth's rotation. Another way to reduce friction is to ensure that the corresponding mating parts are in complete alignment, and everything is tight, and properly adjusted.

My invention, therefore, resides not in any one of these features per se, but rather in the particular combination of all of them herein disclosed. It is distinguished from the prior art in this particular combination of all of its structures for the functions specified.

In order that a detailed description of the invention may be better understood, and that the present contribution to the art can be more fully appreciated, additional features of the invention will be described hereinafter. It should be appreciated by those skilled in the art that the conception and the disclosed specific methods, and structures, may be readily utilized as a basis for modifying or designing other structures, for carrying out the same purposes of the present invention. It should be realized by those skilled in the art, that such equivalent methods and structures do not depart from the spirit and scope of the invention.

In this respect, before explaining at least one embodiment of the invention in detail, it is to be understood that the invention is not limited to the details of construction, and to the arrangements, of the components, as set forth in the following description, or illustrated in the drawings. The invention is capable of other embodiments, and of being practiced and carried out in various ways. Also, it is to be understood that the phraseology, and terminology employed herein, are for the purpose of description, and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the U.S. Patent and Trademark Office, and the public generally, and especially the scientist, engineers and practitioners in the art, who are not familiar with patent or legal terms or phraseology, to determine quickly from a cursory inspection the nature and essence of the technical disclosure of the application. The abstract is neither intended to define that invention of the application, nor it is intended to be limiting as to the scope of the invention in any way.

Accordingly, it is an object of my version of the invention to provide a low-cost, easy-to-manufacture, and easy-to-market continuous operating battery operated fan module.

A further object of my version of the invention is to provide an easy-to-use and versatile continuous operating battery operated fan module.

A significant object of the invention is to provide a continuous operating battery operated fan module that is portable and transportable, and can be easily stored when not needed.

A final but very significant object of the invention is to provide a continuous operating battery operated fan module that is operable where no electric nor sunshine is available.

For a better understanding of the invention, its operating advantages and the specific objects attained by its uses, references should be made to the accompanying drawings, and descriptive matter, in which there is illustrated a preferred embodiment of the invention. The foregoing has outlined some of the more pertinent objects of the invention. These objects should be construed to be merely illustrative of some of the more prominent features, and applications of the present invention. Many other beneficial results can be attained by applying the disclosed invention in a different manner, or by modifying the invention within the scope of the disclosure. Accordingly, other objects and a fuller understanding of the invention may be had, by referring to the summary of the invention, and the detailed description of the preferred embodiment, in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiment of the invention, as illustrated in the accompanying drawings, in which like reference characters refer to the same parts throughout different views. The drawings are not necessarily to scale, emphasis instead being placed upon illustrating the principles of the invention.

FIG. 1 is a perspective view of a continuous operating battery operated fan module illustrating the inter-relationship of all major components.

FIG. 1A is a cut-away perspective view illustrating the wiring configuration.

### DESCRIPTION OF THE PREFERRED EMBODIMENT

Description

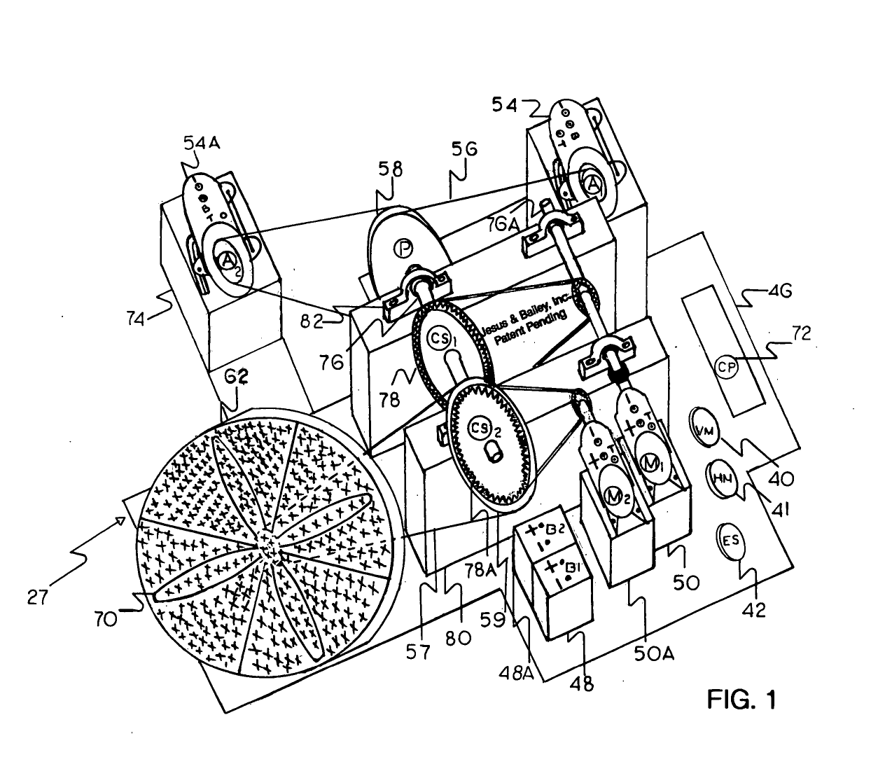

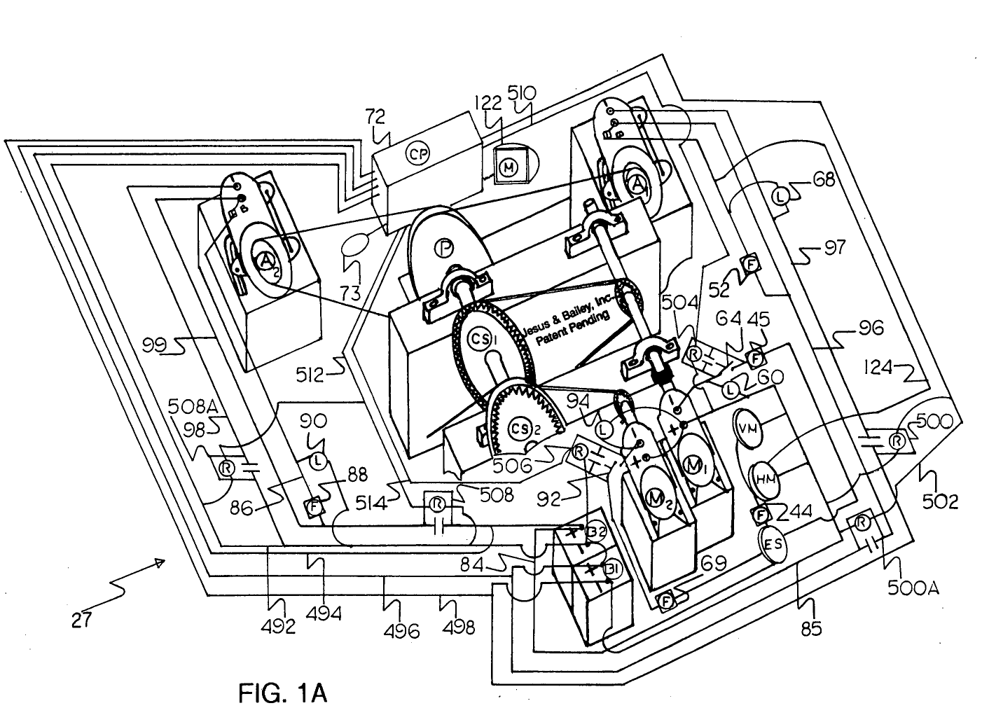

referring now to the drawings and, in particular, to FIGS. 1 & 1A, wherein there is illustrated a typical embodiment of a continuous operating battery operated fan module 27. The present version of the invention 27 is constructed of materials and components that are light weight, durable, and resistant to corrosion and oxidation, such as plastic, aluminum, carbon steel, wood, various composite materials or a combination thereof. The device 27 consist in a main wooden or non-conducted material base or housing 46, of the following parts (note that all switches, lights and meters, should be mounted on separate metal control panels, not shown, or be separated on a single panel, due to the fact that there are three separate circuits whose grounds must not inter-connect): a 24-volt meter 40 to show battery condition, a 24-volt hour meter 41 to indicate how many hours device has operated, a 24-volt emergency shut/off switch 42 to shut down device in an emergency, a 24-volt instrument fuse 44, a pair of 24-volt motor circuit breaker 45 & 69, a pair of 12-volt deep cycle batteries 48 & 48A which are connected in series to give 24-volts, a pair of I-HP-24-volt motors 50 & 50A which are wired to operate in a counter clockwise rotation, a pair of 12-volt fuses 52 & 88, a pair of 12-volt alternators 54 & 54A which are mounted on supports 74 and used to replenish batteries B1 & B2 separately, a pair of pulley belts 56 which is used to drive each alternator with pulley 58, and a pulley belt 57 which is used with pulley 59 to drive fan assembly 62. The device 27 also includes a pair of 24-volt light modules 60 & 94 which is used to indicate when drive motors M1 & M2 are in operation, a pair of 24-volt switches 64 & 92 which used to turn motors M1 & M2 on an off, a pair of 12-volt switches 66 & 86 which are used to excite alternator A1 & A2, a pair of 12-volt lights 68 & 90 which are used to show when alternators are excited. The device 27 also includes a computerized control device 72 which can be used to control the on and off operation of device 27, in the event said device is turned off, for extended periods. The computer 72 would monitor device 27 and turn it on automatically in order to keep the batteries refurbished. Computer 72 is also used to control the re-charging of batteries B1 & B2, one at a time. Wires 498, are probe and 12-volt negative from B1, to computer 72. Wires 496, are probe and 12-volt positive, from B1, to computer 72. Wires 494, are probe and 12-volt negative, from B2, to computer 72. Wires 492, are probe and 12-volt positive from B1, to computer 72. Included also are two jumper relays 504 & 506 which are powered by 12-volt wires 510 & 514, from computer 72, which are used to start device 27 automatically. In addition a monitor 122 is provided to display values and data, and can enunciate problems of the system digitally of by voice prompts, through speaker 73. Four charging relays 500, 500A & 508, 508A powered by 12-volt wires 502 & 512, are added which are used to charge each battery separately. The device 27 also consist of a pair of chain and sprocket drive assemblies 78 & 78A which are mounted on bridge supports 80 and used to operate horse power load shaft 76, via drive shaft 76A. Refer to drawing reference numerals and nomenclature for all values. Said values does not limit the application in any way, as the device 27 can be powered by any other voltage value, or use of other rating, or rotary transmission means.

There are three basic goals that must be achieved in order to achieve perpetual motion of device 27, the first is to achieve enough torque to move all the load and work to be performed by device 27, this can be accomplished by choosing a load torque ratio sufficient to perform all task. Next a speed ratio must be chosen to return the alternator to speed enough to operate efficiently. Next enough volts and amps must be developed to overcome friction and refurbish the batteries, as was described in the summary of the application. Once these three goals are satisfied and the device 27 is properly assembled as shown in FIGS. 1 & 1A the system should be ready for operation.

Referring now to FIG. 1A, The position of all three circuits should be noted as illustrated by the drawing, to prevent cross grounding. Wires 84, 24-volt positive and wire 85, 24-volt negative. Wire 96, 12-volt positive and wire 97, 12-volt negative to alternator (AI). Wire 98, 12-volt negative and wire 99, 12-volt positive to alternator (A2). The sequence of operation are as following: Charge B1 on a conventional trickle charger, until battery is fully charged, to about 14.5-volts. Next place B2, on the same charger and charge to the same value. B1 should maintain about 13-volts, while B2, should have between 14.5 & 13.5-volts. This is very important to have one battery slightly fresher than the other, so that both batteries will not need to be re-charged at the same time. Energize motor (M1) by closing switch 64, the system should be put in motion, and fan blades 70 (FIG. 1) should start rotating, and motor on light 60 should come on. After 60 seconds close switch 92, motor (M2) should be put in motion and motor on light 94 should come on. The unit is now ready to replenish batteries 48 & 48A (FIG. 1), one at a time on a as needed basis, as it is controlled by computer 72, as follows: Computer 72, hereafter called CP72, will monitor the condition of both said batteries B1 & B2, when their is a drop in B1, voltage, CP72 will send a 12-volt signal to charging relays 500 & 500A via wire 502. Said action will close said relay contacts causing alternator A1 to begin to re-charge battery B1 through its internal voltage regulator. When said charging is complete, CP72 will close contact 500 & 500A and send a 12-volt signal to charging relays 508 & 508A via wire 512. Said process will set in motion the charging of battery B2, by alternator A2. The said back and forth action should set in motion continual operation of device 27, without need for a separate charging operation for said batteries, as long as said device is in the operation, and all component parts are operating properly. The said action will create perpetual motion, of device 27. The said actions makes device 27 an improvement over the sighted prior art attempts and products, and as such is patentable, which action the Pro Se applicant request in accordance with all appropriate patent laws, and statutes. Should the need arise to use device 27 on a on and off basis, close switch ES, and switches 64 & 92, then turn switch ES back to the on position. Computer 72 will monitor the condition of batteries B1 & B2. When a drop in volts is registered CP72, will send 12-volt signals to jumper relays 504 & 506 via wires 510 & 514. Said action will place device 27 in operation in order to re-charge said batteries through previously described process. When said batteries are fully charged CP72 will turn device off once more. Said process will keep said batteries re-freshen until device 27 is needed once more to be put in use. DC generators could be used to accomplish the charging process, instead of alternators. A Quick disconnect coupler could be installed between fan 70, to dis-connect said fan when not in use. Note before working on unit all switches must be in the off position, including CP72, on/off switch, not shown.

Since we are using 24-volts to operate device 27, and we are using 24-volts to convert to the 14.5-volts it takes to re-charge each battery one at a time, we are not in violation of the laws of energy conversion. If we were using a 12-volt battery to convert to the 14.5-volts needed to re-charge a 12-volt battery we would.

Since both alternators together will produce more than 30-volts during the charging process, and it only takes 24-volts to operate device 27, under normal circumstances we will have enough volts to operate the system, charge the batteries and replace what is lost due to friction, therefore we are not in violation of the second law of thermodynamics. The said processes makes an exception to the rules of the perpetual motion machine, thereby creating a new phenomena, a new useful, novel, unobvious perpetual motion machine art, and science, has been disclosed.

Since the two alternators together can produce over 30-volts, and it takes 24-volts to operate the system, and 2.5-volts to charge each battery one at a time, this equals 26.5-volts. Hens we have 3.5-volts left to overcome friction, this represents 1/6.857 of the 24-volts (1/6.857×100) equals 14.58%, to overcome friction. If we subtract the 14.58% from 100%, we get 85.42%. So then if the system is 85.42% efficient we can have perpetual motion.

### RAMIFICATION CONCLUSION AND SCOPE OF INVENTION

From the foregoing, it will be readily understood by persons skilled in the art that an improved perpetual motion battery operated device has been provided. The invention is relatively simple and easy to manufacture, yet affords a variety of uses. While my description contains many specifications, these should not be construed as limitations on the scope of the invention, but rather as an exemplification of the preferred embodiment thereof. For example, any number, type or voltage of rechargeable batteries could be chosen rather than that which is specified in the present application. The foregoing is considered as illustrative only of the principles of the invention. Further, since numerous modifications and changes will readily occur to those skilled in the art, it is not desired to limit the invention to the exact construction and operation shown and described; accordingly all suitable modifications and equivalents may be resorted to, falling within the scope of the invention. Although this invention has been described in its preferred form with a certain degree of particularity, it is understood that the present disclosure of the preferred form has been made only by way of example, and numerous changes in the details of construction and combination and arrangement of parts may be resorted to without departing from the spirit and scope of the invention.

1. What I claim is the independent means to produce perpetual motion within a battery operated device by eliminating the need for a separate charging operation comprising:
(a) providing DC motors with means to increase torque enough to perform all needed work and having means to
(b) performing operation of charging components at speed enough to produce enough volts and amps to overcome friction and charge
(c) operating batteries which are connected in series to achieve desired volts and are refurbished separately one at a time by its own charging component and are installed in
(d) housing capable of separating circuits with meters switches fuses lights and computer to monitor protect and control said device whereby as said device is operated said charging components refurbishes said batteries thereby said process which is an improvement over prior art attempts establishes perpetual motion.
